(19) United States
(12) Patent Application Publication
(10) Pub. No.: US 2025/0177886 A1
(43) Pub. Date: Jun. 5, 2025

(54) FILTER MANIFOLD FOR A FILTER ASSEMBLY

(71) Applicant: FISHER & PAYKEL APPLIANCES LIMITED, EAST TAMAKI (NZ)

(72) Inventor: Hock Khuen CHEOW, Auckland (NZ)

(21) Appl. No.: 18/965,300

(22) Filed: Dec. 2, 2024

(30) Foreign Application Priority Data
Dec. 1, 2023 (NZ) 806160

(51) Int. Cl. B01D 27/08

(52) U.S. Cl. CPC B01D 27/08; B01D 2201/302; B01D 2201/34

(57) ABSTRACT

A filter manifold for a filter assembly includes an outer casing having a body with an inner surface defining a chamber. A first protrusion extends radially inwardly from the inner surface of the body and extends arcuately along an inner circumference of the chamber. An inner casing is rotatably arranged in the chamber of the outer casing and includes a cylindrical structure having an outer surface arranged facing the inner surface of the body. A second protrusion extends radially outwardly from the outer surface of the cylindrical structure and extends arcuately along an outer circumference of the cylindrical structure. The first protrusion and the second protrusion facilitate an insertion of the inner casing into the chamber along an insertion axis of the body such that the rotational axis of the inner casing, once fully inserted, is arranged at an offset from the insertion axis of the outer casing.

### TECHNICAL FIELD

The present disclosure relates, generally, to a filter assembly for a refrigeration appliance and more particularly relates to a water filter manifold for a refrigeration appliance, the manifold having an outer casing and inner casing rotatably arranged inside the outer casing.

### BACKGROUND INFORMATION

A water filter assembly is used with (i.e., either provided within or external to) a refrigeration appliance to filter water that is provided chilled to a dispenser and/or to an ice maker of the refrigeration appliance. Generally, the filter assembly includes a filter “head” or manifold that is fixedly mounted to, or within, a refrigeration appliance cabinet, or to an alcove wall adjacent the refrigeration appliance. The manifold has an incoming water connection for unfiltered water from a domestic/commercial water supply, and an outgoing water connection for filtered water. A filter cartridge (containing, for example, a carbon block) is removably coupled to the manifold, to filter the incoming unfiltered water. U.S. Pat. No. 10,099,162B2 discloses an exemplary filter assembly for a refrigeration appliance, including a filter cartridge.

The manifold generally has an outer body, stationary housing, and an inner rotatable body to which the filter cartridge is removably and non-rotatably connected. Rotating the filter cartridge, once it has been inserted into the manifold, causes the inner body to rotate with the filter cartridge which aligns inlet and outlet ports on the inner body with corresponding inlet and outlet ports on the outer body. Elastomeric seals are provided between the inner and outer parts of the manifold at the inlet and outlet ports. To engage the filter cartridge with the manifold, a top end of the filter cartridge is first pushed axially into an opening in the manifold. Once the end of the filter cartridge is inserted and connected with the inner body, the filter cartridge is rotated, with the inner body, so that the filter cartridge is locked to the manifold. This also aligns the ports on the inner, rotatable body to the ports on the outer body. However, during assembly of the manifold, it may be possible that during insertion of the inner body within the outer body, contact between the elastomeric seals and an adjacent surface could damage the seal.

### SUMMARY OF DISCLOSURE

In a first aspect, the invention may broadly be said to consist in a filter manifold for a filter assembly of a refrigeration appliance. The filter assembly includes a filter cartridge adapted to be removably coupled to the filter manifold. The filter manifold comprises an outer casing including a body having a first axial end, a second axial end arranged opposite to the first axial end, and an inner surface defining a chamber with an opening of the chamber arranged at the first axial end. The outer casing also includes a first protrusion extending radially inwardly from the inner surface of the body and extending arcuately along an inner circumference of the chamber. The filter manifold further includes an inner casing rotatably arranged in the chamber of the outer casing between a first rotational position and a second rotational position. The inner casing is adapted to be removably engaged to the filter cartridge and includes a cylindrical structure having a rotational axis about which the inner casing rotates, a first end arranged proximate to the first axial end of the body, a second end disposed proximate to the second axial end of the body, and an outer surface arranged facing the inner surface of the body. The inner casing further includes a second protrusion extending radially outwardly from the outer surface of the cylindrical structure and extending arcuately along an outer circumference of the cylindrical structure. The first protrusion and the second protrusion facilitate an insertion of the inner casing into the chamber along an insertion axis of the body such that the rotational axis of the inner casing, once fully inserted, is arranged at an offset from the insertion axis of the outer casing.

In some additional, alternative, or selectively cumulative embodiments, the first protrusion is arranged proximate to the second axial end of the body, and the second protrusion is arranged proximate to the first end of the cylindrical structure.

In some additional, alternative, or selectively cumulative embodiments, in the second rotational position, the filter cartridge is secured with the filter manifold, and the inner casing is rotated to the first rotational position to enable a removal of the filter cartridge from the filter manifold.

In some additional, alternative, or selectively cumulative embodiments, an inner diameter of the chamber is greater than an outer diameter of the cylindrical structure.

In some additional, alternative, or selectively cumulative embodiments, the inner surface of the body defines an inlet port and an outlet port, and the outer surface of the cylindrical structure defines an inlet opening and outlet opening. The inlet opening and the outlet opening are, respectively, arranged aligned with the inlet port and the outlet port at the second rotational position of the inner casing.

In some additional, alternative, or selectively cumulative embodiments, the inner surface of the body defines a first groove extending entirely around the inlet port, and a second groove extending entirely around the outlet port.

In some additional, alternative, or selectively cumulative embodiments, the manifold further includes a first seal arranged inside the first groove and extending partly outwardly from the first groove and arranged contacting the outer surface of the cylindrical structure. The manifold also includes a second seal arranged inside the second groove and extending partly outwardly from the second groove and arranged contacting the outer surface of the cylindrical structure.

In some additional, alternative, or selectively cumulative embodiments, the first and second seals are compressed only when the first and second protrusions are in contact with their opposing surface.

In some additional, alternative, or selectively cumulative embodiments, the first protrusion is formed in a semi-circular shape about the rotational axis of the cylindrical structure and the second protrusion is formed in a semi-circular shape about the insertion axis of the body.

In some additional, alternative, or selectively cumulative embodiments, the first and second protrusions contact their opposing surface at substantially the same amount of insertion of the inner casing into the chamber of the body.

In a second aspect, the invention consists in a filter assembly for a refrigeration appliance and adapted to filter water. The filter assembly comprises a filter manifold according to the first aspect, and a filter cartridge partially extending inside the inner casing and removably coupled to the inner casing. The filter cartridge is arranged to receive water from the filter manifold and to filter the water.

In a third aspect, the invention may broadly be said to consist in a filter manifold for a filter assembly of a refrigeration appliance. The filter assembly includes a filter cartridge adapted to be removably coupled to the filter manifold. The filter manifold comprises an outer casing including a body having an inner surface defining a chamber. The inner surface further defines an inlet port, an outlet port, a first groove extending entirely around the inlet port, and a second groove extending entirely around the outlet port. The filter manifold further comprised an inner casing rotatably arranged in the chamber of the outer casing and including a cylindrical structure having a rotational axis about which the inner casing rotates, and an outer surface arranged facing the inner surface of the body. The outer surface defines an inlet opening and an outlet opening, respectively, arranged aligned with the inlet port and the outlet port of the body at a rotational position of the inner casing. The filter manifold also includes a first seal arranged inside the first groove and extending partly outwardly from the first groove and arranged contacting the outer surface of the cylindrical structure, and a second seal arranged inside the second groove and extending partly outwardly from the second groove and arranged contacting the outer surface of the cylindrical structure.

In some additional, alternative, or selectively cumulative embodiments, the outer casing includes a first protrusion extending radially inwardly from the inner surface of the body and extending arcuately along an inner circumference of the chamber. Moreover, the cylindrical structure includes a second protrusion extending radially outwardly from the outer surface of the cylindrical structure and extending arcuately along an outer circumference of the cylindrical structure. The first protrusion and the second protrusion facilitate an insertion of the inner casing into the chamber along an insertion axis of the body such that the rotational axis of the inner casing, once fully inserted, is arranged at an offset from the insertion axis of the outer casing.

In some additional, alternative, or selectively cumulative embodiments, the body includes a first axial end and a second axial end arranged opposite to the first axial end, an opening of the chamber defined at the first axial end. Moreover, the cylindrical structure includes a first end arranged proximate to the first axial end of the body and a second end arranged proximate to the second axial end of the body.

In some additional, alternative, or selectively cumulative embodiments, the first protrusion is arranged proximate to the second axial end of the body, and the second protrusion is arranged proximate to the first end of the cylindrical structure.

In some additional, alternative, or selectively cumulative embodiments, the first protrusion is formed in a semi-circular shape about the rotational axis of the cylindrical structure and the second protrusion is formed in a semi-circular shape about the insertion axis of the body.

In some additional, alternative, or selectively cumulative embodiments, the first and second protrusions contact respective opposing surfaces at substantially the same amount of insertion of the inner casing into the chamber of the body.

In some additional, alternative, or selectively cumulative embodiments, an inner diameter of the chamber is greater than an outer diameter of the cylindrical structure.

In some additional, alternative, or selectively cumulative embodiments, the first and second seals are compressed only when the first and second protrusions are in contact with their respective opposing surfaces.

In a fourth aspect, the invention consists in a filter assembly for a refrigeration appliance and adapted to filter water. The filter assembly comprises the filter manifold according to the third aspect, and a filter cartridge partially extending inside the inner casing and removably coupled to the inner casing. The filter cartridge is arranged to receive water from the filter manifold and to filter the water.

Additional aspects and advantages will be apparent from the following detailed description of example embodiments, which proceeds with reference to the accompanying drawings.

### BRIEF DESCRIPTION OF THE DRAWINGS

FIG. 1 illustrates a perspective view of a filter assembly having a filter manifold and a filter cartridge coupled to the filter manifold, in accordance with an embodiment of the disclosure;

FIG. 2 illustrates a perspective view of the filter manifold of FIG. 1, in accordance with an embodiment of the disclosure;

FIG. 3 illustrates a sectional view of the filter manifold of FIG. 2 having an outer casing and an inner casing arranged inside the outer casing with a rotational axis of the inner casing disposed at an offset from an insertion axis of the outer casing, in accordance with an embodiment of the disclosure;

FIG. 4 illustrates an exploded view of the filter manifold of FIG. 2, in accordance with an embodiment of the disclosure;

FIG. 5 illustrates a perspective view of a body of the filter manifold outer casing of FIG. 4 depicting a first protrusion, in accordance with an embodiment of the disclosure;

FIG. 6 illustrates another perspective view of the body of the outer casing of FIG. 4 depicting a first groove and a second groove in the side wall of an inner chamber, in accordance with an embodiment of the disclosure;

FIG. 7 illustrates a sectional perspective view of the outer casing of FIG. 4 depicting the first groove and the second groove, in accordance with an embodiment of the disclosure;

FIG. 8 illustrates a sectional perspective view of the outer casing of FIG. 4 depicting a first seal arranged inside the first groove and a second seal arranged inside the second groove, in accordance with an embodiment of the disclosure;

FIG. 9 illustrates a perspective view of the inner casing of FIG. 4, in accordance with an embodiment of the disclosure;

FIG. 10 illustrates another perspective view of the inner casing of FIG. 4 depicting engagement structures of the inner casing, in accordance with an embodiment of the disclosure;

FIG. 11 illustrates a top perspective view of a cover of the outer casing of FIG. 4 depicting a pair of tabs having inclined surfaces, in accordance with an embodiment of the disclosure;

FIG. 12 illustrates a bottom perspective view of the cover of the outer casing of FIG. 4 depicting a pair of tapered surfaces for guiding the filter cartridge axially inwardly during rotation, in accordance with an embodiment of the disclosure;

FIG. 13 illustrates a perspective view of the filter cartridge of FIG. 1, in accordance with an embodiment of the disclosure; and

FIG. 14 is a perspective view from the side and front of a refrigeration appliance incorporating, or connected so as to receive filtered water from, the filter assembly of FIG. 1.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

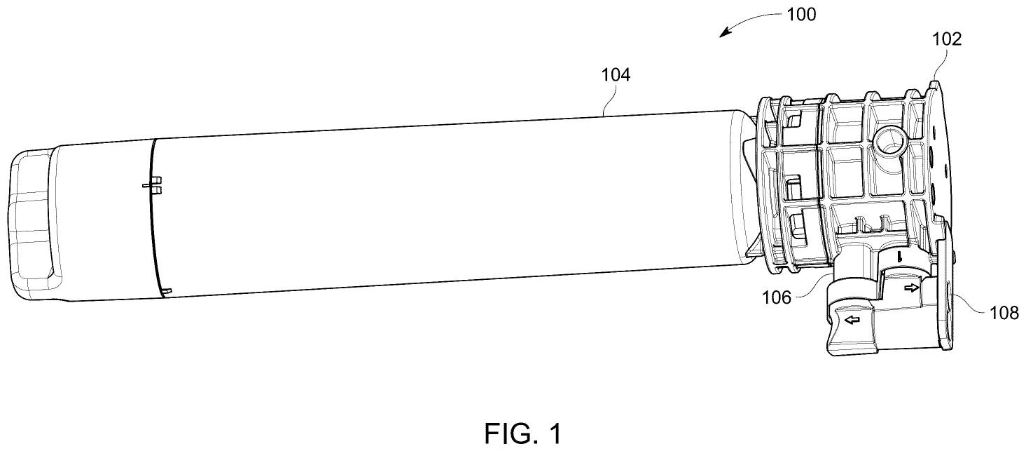

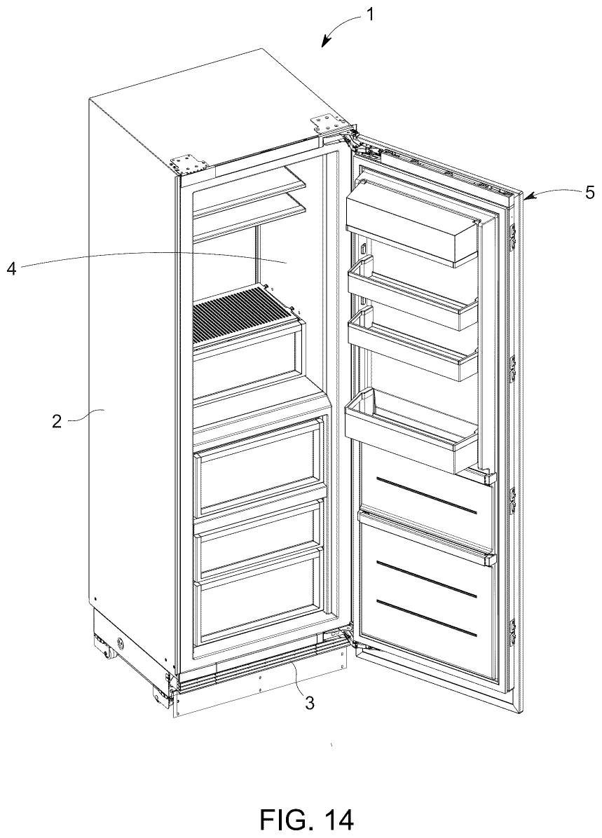

Referring to FIG. 1, a filter assembly 100 for a refrigeration appliance 1 (such as a refrigerator, or freezer, or refrigerator/freezer-see FIG. 14, for example) is shown. The filter assembly 100 may be arranged to filter water provided to the refrigeration appliance from a water supply (not shown), such as a municipal water source or a well and remove contaminants, such as chlorine, chloroform, lead, arsenic, pharmaceuticals, microbes, etc., from water supplied to the refrigeration appliance and which may be dispensed to the user via a water dispenser mounted, for example, in a wall 4 of the cabinet or in the front face of a door 5. Filter assembly 100 may also or instead supply filtered water to an ice maker located within a freezer compartment of the refrigeration appliance 1 for manufacturing ice cubes. The filter assembly 100 may be mounted to a refrigeration appliance cabinet 2 (such as behind a grill 3 of a base of the cabinet, within a plinth) or an alcove wall adjacent to the refrigeration appliance. Although the filter assembly 100 is contemplated for a refrigeration appliance, the filter assembly may be used with an ice maker, as a point of use water filtration system, e.g., installed beneath a kitchen sink, or as a point of entry water filtration system for an entire household. Thus, the present subject matter is not limited to any particular installation or location for filtering assembly 100.

As shown, the filter assembly 100 includes a filter manifold 102 and a filter cartridge 104 removably mounted to filter manifold 102, hereinafter simply referred to as manifold 102. Manifold 102 may include one or more mounting brackets to mount the filter assembly 100 to a cabinet of the refrigeration appliance 1, to a kitchen cabinet beneath a kitchen sink, or to a wall within a house. Manifold 102 also defines an entrance 106 and an exit 108. Entrance 106 may be in fluid communication, for example via plastic tubing with a water supply and receive unfiltered water from the water supply. From entrance 106, such unfiltered water is directed into the filter cartridge 104, passes through the filter cartridge 104 and exits manifold 102 at the exit 108 as filtered water for connection via, for example plastic tubing, to an ice maker or water dispenser.

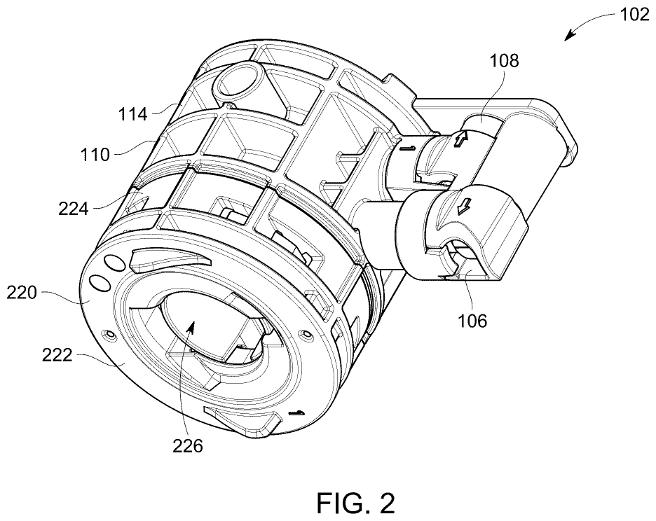

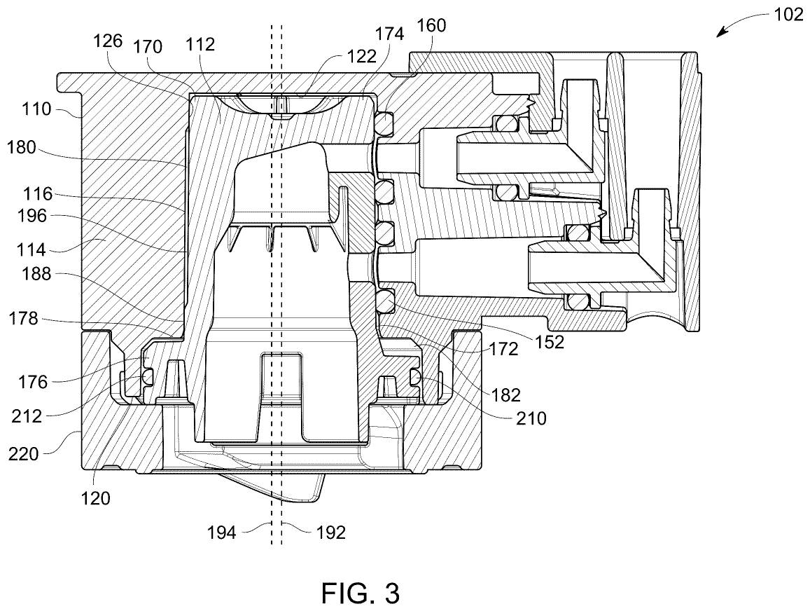

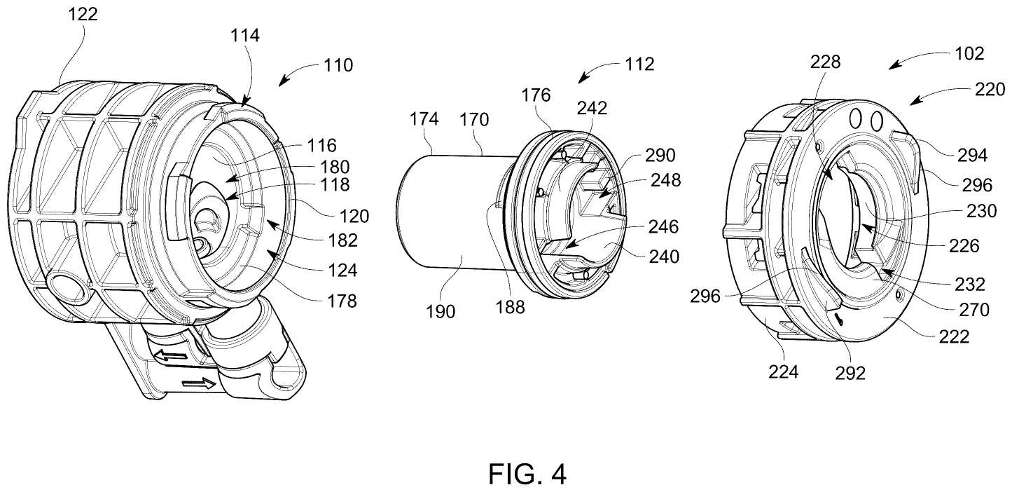

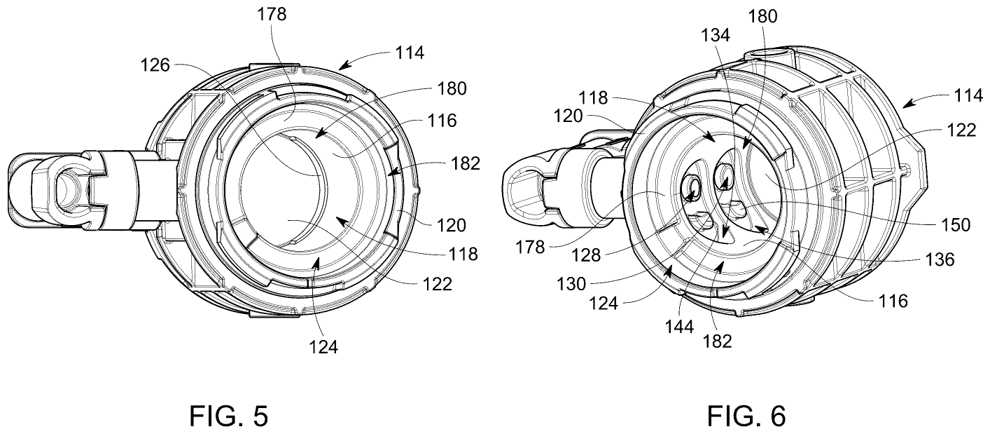

Further, referring to FIGS. 2 and 4, the manifold 102 includes an outer casing 110 and an inner casing 112 rotatably engaged with the outer casing 110 and extending at least partially inside the outer casing 110. The inner casing 112 is positioned inside the outer casing 110, rotatable between a first rotational position and a second rotational position. In the first rotational position, inner casing 112 facilitates an axial disengagement and removal of the filter cartridge 104 from the manifold 102. As shown, the outer casing 110 includes a body 114 having an inner surface 116 defining a substantially cylindrical bore or chamber 118 extending from a first axial end 120 of the body 114 to a second axial end 122 (see FIG. 6) of the body 114. Referring to FIGS. 3 to 6, the body 114 defines an opening 124 of the chamber 118 at the first axial end 120, while the second axial end 122 is a closed end of the body 114 i.e., outer casing 110. Moreover, the outer casing 110 includes a protrusion 126 (i.e., first protrusion 126, best shown in FIG. 5) extending inwardly inside the chamber 118 from the inner surface 116 of the body 114 and extending arcuately along an inner circumference of the body 114 in a circumferential direction. As shown, the first protrusion 126 includes a semi-circular shape and extends circumferentially over a span or around half of the inner surface 116 of the chamber 118. As shown the first protrusion 126 is disposed proximate to the second axial end 122 of the body 114.

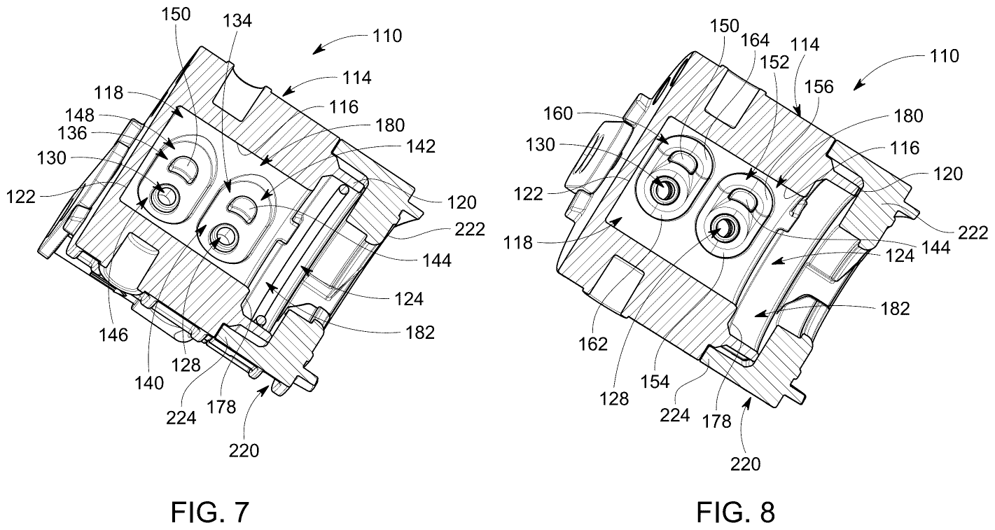

Moreover, as best shown in FIGS. 6 and 7, the inner surface 116 defines an inlet port 128 and an outlet port 130 that are respectively arranged in fluid communication with entrance 106 and exit 108 of the manifold 102. Accordingly, the inlet port 128 receives unfiltered water from the entrance 106, while the outlet port 130 facilitates a flow of the filtered water to the exit 108. Additionally, the inner surface 116 defines a first recess, depression or groove 134 extending entirely around the inlet port 128 and a second recess, depression or groove 136 extending entirely around the outlet port 130. As shown in FIG. 7, the first groove 134 includes a first region 140 enclosing the inlet port 128 and a second region 142 that encloses a first raised portion 144 of the body 124. Similarly, the second groove 136 includes a first region 146 enclosing the outlet port 136 and a second region 148 that encloses a second raised portion 150. The first raised portion 144 and the second raised portion 150 are arranged away from the respective ports 134, 136 in a direction of the rotation of the inner casing 112 inside the chamber 118.

Referring to FIG. 8, the manifold 102 further includes a first seal 152 having a first portion 154 arranged inside the first region 140 of the first groove 134 and a second portion 156 extending inside the second region 142 of the first groove 134. Accordingly, the first portion 154 of the first seal 152 is arranged enclosing the inlet port 128, while the second portion 156 of the first seal 152 is disposed enclosing the first raised portion 144. Similarly, the manifold includes a second seal 160 having a first portion 162 arranged inside the first region 146 of the second groove 136 and a second portion 164 extending inside the second region 148 of the second groove 136. Accordingly, the first portion 162 of the second seal 160 is arranged enclosing the inlet port 130, while the second portion 164 of the second seal 160 is disposed enclosing the second raised portion 150. The first and second seals each therefore resemble a “figure 8” and remain attached to the outer casing by gripping to the raised portions and inlet/outlet ports. The first seal 152 and the second seal 160 prevent a leakage of water between the inner casing 112 and the outer casing 114. The first seal 152 and the second seal 160 are arranged inside the grooves 134, 136 such that a portion of the seals 152, 160 extend outwardly of the grooves 134, 136, and such that they may press against and form a seal against the inner casing 112 when arranged inside the chamber 118.

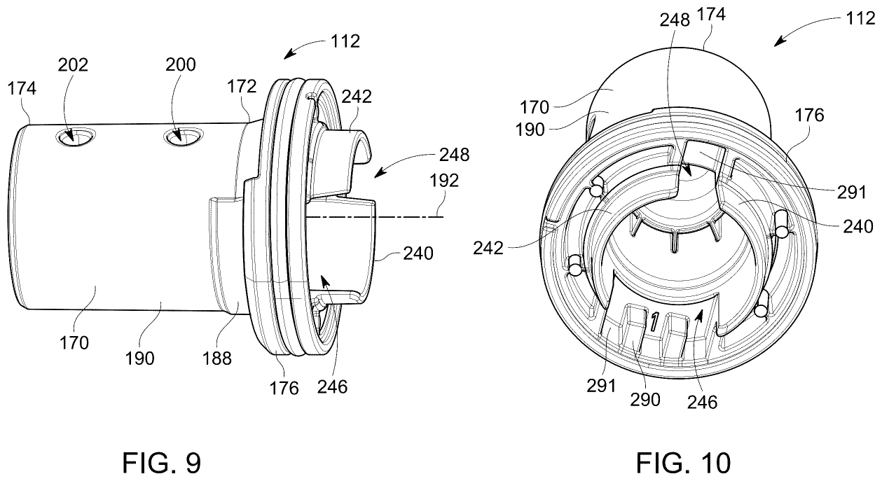

Referring to FIG. 4, FIG. 9, and FIG. 10, the inner casing 112 includes a hollow cylindrical structure 170 having a first end 172 and a second end 174 arranged opposite to the first end 170, and a flange structure 176 extending in a longitudinal direction from the first end 172 such that the first end 172 of the cylindrical structure 170 is arranged between the flange structure 176 and the second end 174 in the longitudinal or axial direction. Also, the flange structure 176 extends radially outwardly from an outer surface of the cylindrical structure 170. As shown in FIG. 3, the flange structure 176 extends inside the chamber 118 and abuts a seat 178 of the body 114 defined inside the chamber 118, radially about its longitudinal axis. Accordingly, as shown in FIGS. 4, 7 and 8, the chamber 118 includes a first chamber portion 180 extending from the second axial end 122 towards the first axial end 120, and a second chamber portion 182 extending from the first chamber portion 180 to the first axial end 120. In an engagement of the inner casing 112 inside the outer casing 110, the flange structure 176 is arranged inside the second chamber portion 182, as shown in FIG. 3.

Further, referring back to FIGS. 4 and 9, the inner casing 112 includes a protrusion 188 (i.e., second protrusion 188) extending radially outwardly from an outer surface 190 of the cylindrical structure 170 and arranged at the first end 172 of the cylindrical structure 170. As with the first protrusion 126, the second protrusion 188 extends arcuately about a span of an outer circumference of the cylindrical structure 170 in the circumferential direction, and includes a semi-circular shape. In the assembly of the inner casing 112 inside the outer casing 110, as shown in FIG. 3, the first end 172 of the cylindrical structure 170 is arranged at the first axial end 120 of the body 114 and the second end 174 of the cylindrical structure 170 is arranged proximate to the second axial end 122 of the body 114 with the second protrusion 188 arranged inside the first chamber portion 180. The first protrusion 126 and the second protrusion 188 together facilitate a positioning of the cylindrical structure 170 (i.e., inner casing 112) inside the chamber 118 such that a longitudinal rotational axis 192 of the inner casing 112, i.e., of the cylindrical structure 170, is arranged at an offset from a longitudinal insertion axis 194 of the outer casing 110, as exemplified in FIG. 3. It should be noted that the position of insertion axis 194 has been exaggerated in FIG. 3-the offset between axes 192 and 194 need only be slightly greater than the distance that seals 152, 160 extend inwardly beyond inner surface 116 of body 114, for example the offset distance could be between about 0.4 mm and about 1.2 mm, or less than about 2 mm.

At the start of insertion of the inner casing 112, i.e., the cylindrical structure 170, inside the chamber 118, the rotational axis 192 of the inner casing 112 is aligned with the insertion axis 194 of outer casing 110. However, at the end of the (linear) insertion along the insertion axis, the first protrusion 126 and the second protrusion 188 contact respective opposing surfaces, i.e., outer surface 190 of the cylindrical structure 170 and inner surface 116 of the chamber 118, at substantially the same amount of insertion of the inner casing 112 into the chamber 118. Accordingly, the protrusions 126, 188 push the cylindrical structure 170, i.e., the inner casing 112, laterally towards the seals 152, 160 during the final stage of insertion and thereby offset the rotational axis 192 of the inner casing 112, i.e., cylindrical structure 170, from the insertion axis 194 of outer casing 110. Therefore, during assembly of manifold 102, (linear) insertion of the cylindrical structure 170 inside the chamber 118 occurs while the outer surface 190 of the cylindrical structure 170 is arranged at a distance from the seals 152, 160, thereby a rubbing and pressing of the seals 152, 160 by the inner casing 112 during insertion of the cylindrical structure 170 inside the chamber 118 is prevented, reducing the risk of damage to the seals 152, 160 during assembly of the manifold. It may be appreciated that the cylindrical structure 170 upon full insertion inside the chamber 118, presses the seals 152, 160, preventing leakage of the water from inlet and outlet ports 128, 130 inside the chamber 118. To enable the insertion of the cylindrical structure 170 inside the chamber 118 along the insertion axis 194, an inner diameter of the chamber 118 is greater than an outer diameter of the cylindrical structure 170.

Further, in the assembly of the inner casing 112 (i.e., the cylindrical structure 170) inside the outer casing 110 (i.e., the chamber 118), an air gap 196 (shown in FIG. 3) is defined between the inner surface 116 of the body 114 and the outer surface 190 of the cylindrical structure 170. Moreover, as shown in FIG. 9, the outer surface 190 of the cylindrical structure 170 defines an inlet opening 200 and an outlet opening 202 that are aligned, respectively, with the inlet port 128 and the outlet port 130 of the outer casing 110 to allow exchange of water therebetween when the inner casing 112 is arranged in the second rotational position. In the second rotational position, as shown in FIG. 3, the first seal 152 and the second seal 160 are pressed against the outer surface 190 of the cylindrical structure 170, sealing any leakage of water to the air gap 196.

When the inner casing 112 is rotated towards the first rotational position from the second rotational position, by rotating filter cartridge 104 in an anti-clockwise direction, for example, the openings 200, 202 of the inner casing 112 move away from the first regions 140, 146 to the second regions 142, 148 of the grooves 134, 136. In the second regions 142, 148, although the openings 200, 202 are disconnected from the ports 128, 130, the seals 152, 156 (i.e., the second portions 156, 164 of the seals 152, 160) still prevent the exit of the water from the filter cartridge 104, blocking openings 200 and 202 and retaining water pressure inside the filter cartridge 104 arranged inside the inner casing 112. Upon further rotation of the inner casing 112 towards the first rotational position, the openings 200, 202 are both fluidly connected to the chamber 118 (i.e., the air gap 196), equalising pressure with within filter cartridge 104 with air gap 196 and potentially releasing some water inside the air gap 196. To prevent leakage of water from the air gap 196, a radial seal 210, for example, O-ring 212, as shown in FIG. 3, is disposed between an outer circumferential surface of flange structure 176 and the adjacent inner circumferential surface of the body 114 associated with the second chamber portion 182. This arrangement reduces the occurrence, that is prevalent in prior filter assembly designs during disconnection of the filter cartridge 104 from the manifold 102, of the filter cartridge 104 tending to “shoot out” of the manifold 102 as it is rotated to disconnect the openings 200, 202 of the inner casing 112 due to the sudden change from the openings 200, 202 being connected to the pressurised water supply and then abruptly exposed to atmospheric pressure.

Additionally, referring to FIGS. 4, 11, and 12, the outer casing 110 includes a cover 220 coupled to the body 114 and arranged covering the opening 124 of the chamber 118 and includes a disc-shaped base 222 and a peripheral wall 224 extending circularly around an outer edge of the base 222. The base 222 defines a cavity 226 arranged substantially centrally to the base 222 and coaxial with the opening 124 of the chamber 118. The cavity 226 is arranged, as best shown in FIG. 3, at a longitudinal or axial offset from the opening 124 of chamber 118 defining a gap therebetween that is covered by the wall 224. The wall 224 is engaged with the body 114 of the outer casing 110. Further, the base 222 defines a first slot 228 extending in a radial outward direction from an inner surface 230 of the cavity 226 in base 222 and a second slot 232 arranged substantially opposite to the first slot 228 and extending in a radial outward direction from the inner surface 230. As shown, a circumferential width of the first slot 228 is larger than a circumferential width of the second slot 232. Accordingly, two arcuate surface portions 234, 236 of the inner surface 230 of the cavity 226 in base 222 are defined between the slots 228, 232.

Corresponding to the arcuate surface portions 234, 236, referring back to FIGS. 4, 9, and 10, the inner casing 112 includes a pair of arcuate members 240, 242 extending in a longitudinal direction from the flange structure 176 and arranged on opposite sides of the rotational axis of cylindrical structure 170 wherein the flange structure 176 is arranged between the cylindrical structure 170 and the arcuate members 240, 242 in the longitudinal direction. The pair of arcuate members 240, 242 are arranged opposite to each other and are separated from each other via a first gap 246 and a second gap 248 diametrically opposed to the first gap. The first gap 246 has a size and a shape corresponding to the first slot 228 of the cover 220, while the second gap 248 has a size and shape corresponding to the second slot 232 of the cover 220. In the assembly of the inner casing 112 with the outer casing 110, a portion of the arcuate members 240, 242 are arranged inside the cavity 226 abutting a step 250 of the cover 220. The step 250 aids in maintaining axial alignment between the inner casing 112 and outer casing 110 during rotation of the inner casing 112 and general operation of the filter assembly 100.

Further, in the first rotational position of the inner casing 112 relative to the outer casing 110, the arcuate members 240, 242 are arranged abutting the arcuate surface portions 234, 236 of the base 222 with first slot 228 arranged aligned with the first gap 246 and the second slot 232 aligned with the second gap 248 to facilitate a removal of the filter cartridge 104 from the manifold 102. Accordingly, the arcuate members 240, 242, the gaps 246, 248, the arcuate surface portions 234, 236, and the slots 228, 232 act as alignment features to correctly align the inner casing 112 with the outer casing 110 to enable removal of the filter cartridge 104 from the manifold 102.

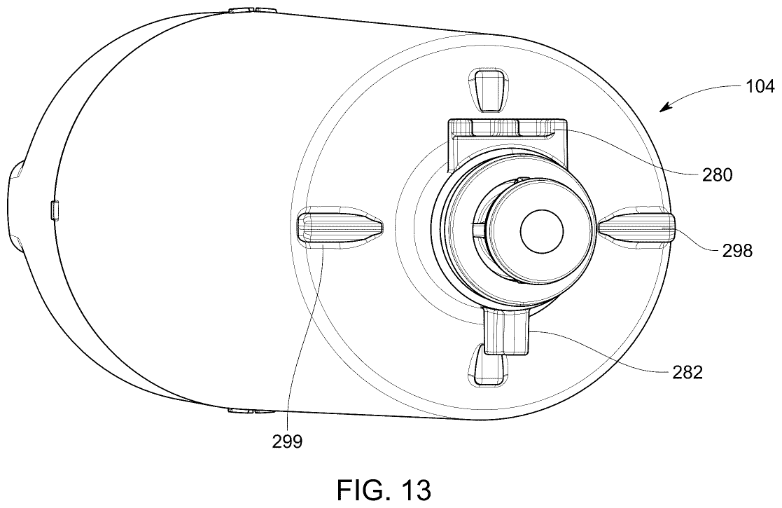

Moreover, as shown in FIG. 12, the cover 220 includes a pair of guide structures 260, 262 to guide and insert radially-extending lugs of the filter cartridge 104 as a neck portion of the filter cartridge 104 (the neck portion encompassing filter inlet and outlet ports) is inserted inside the inner casing 112 to engage the filter cartridge 104 with the inner casing 112. As shown, the guide structures 260, 262 include a pair of tapered surfaces 264, 266 extending from a first end face 268 of the base 222 towards a second end face 270 of the base 222. As shown, a first tapered surface 264 extends from the first end face 268 to the first slot 246 in the circumferential direction, while a second tapered surface 266 extends from the second end face 270 to the second slot 248 in the circumferential direction. Accordingly, as the neck of the filter cartridge 104 is inserted inside the inner casing 112 through the cover 220, a first lug 280 (shown in FIG. 13) of the filter cartridge 104 is arranged inside the first slot 228 of the cover 220 and a second lug 282 (also shown in FIG. 13) of the filter cartridge 104 is arranged inside the second slot 232 of the cover 220.

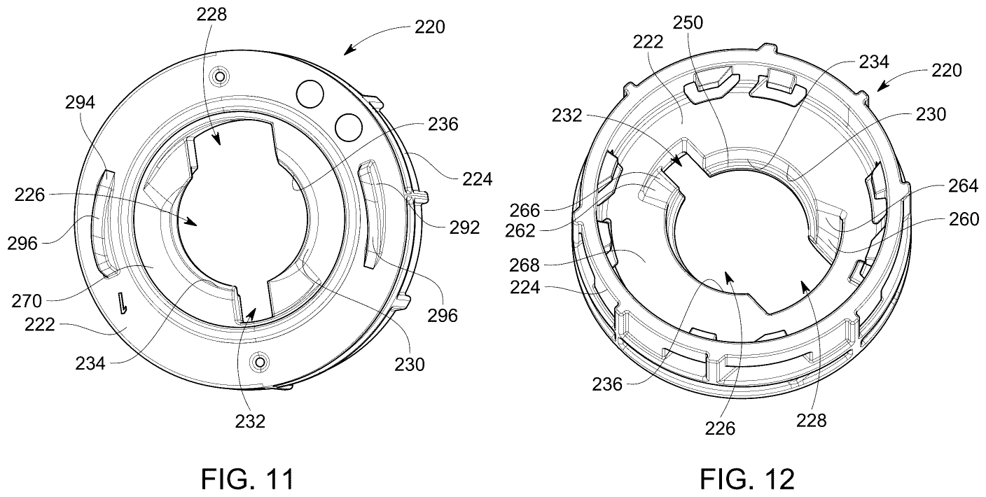

Subsequently, as the filter cartridge 104 is initially turned/rotated in a first direction (for example, clockwise), corresponding surfaces of the lugs 280, 282 move along the tapered surfaces 264, 266 drawing the filter cartridge 104 axially further into the manifold, correctly positioning the filter cartridge 104 and fully engaging the lugs 280, 282 with engagement structures 290 and recesses 291 (shown in FIG. 10) of the inner casing 112. Further, referring to FIGS. 4 and 11, the cover 220 includes a pair of tabs 292, 294 protruding in the longitudinal direction from the second end face 270 of the base 222 and arranged diametrically opposite to each other about the longitudinal rotational axis 192 of the manifold. Each of the tabs 292, 294 include a ramped or inclined surface 296 along which a ridge 298, 299 of the filter cartridge 104 (the ridges are also visible in FIG. 1) slides to enable a movement of the filter cartridge 104 in axial outward direction as the filter cartridge 104 is moved in a second rotational direction (for example, anticlockwise) during an end of travel of the inner casing 112 from the second rotational position to the first rotational position. This helps in disengaging the keys 280, 282 from the engagement structures 290 and removal of the filter cartridge 104 from the manifold 102.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims.

1. A filter manifold for a filter assembly of a refrigeration appliance, the filter assembly including a filter cartridge adapted to be removably coupled to the filter manifold, the filter manifold comprising:
an outer casing including
a body having a first axial end, a second axial end arranged opposite to the first axial end, and an inner surface defining a chamber with an opening of the chamber arranged at the first axial end, and
a first protrusion extending radially inwardly from the inner surface of the body and extending arcuately along an inner circumference of the chamber; and
an inner casing rotatably arranged in the chamber of the outer casing between a first rotational position and a second rotational position, the inner casing adapted to be removably engaged to the filter cartridge and including:
a cylindrical structure having a rotational axis about which the inner casing rotates, a first end arranged proximate to the first axial end of the body, a second end disposed proximate to the second axial end of the body, and an outer surface arranged facing the inner surface of the body, and
a second protrusion extending radially outwardly from the outer surface of the cylindrical structure and extending arcuately along an outer circumference of the cylindrical structure,
wherein the first protrusion and the second protrusion facilitate an insertion of the inner casing into the chamber along an insertion axis of the body such that the rotational axis of the inner casing, once fully inserted, is arranged at an offset from the insertion axis of the outer casing.

2. The filter manifold of claim 1, wherein
the first protrusion is arranged proximate to the second axial end of the body, and
the second protrusion is arranged proximate to the first end of the cylindrical structure.

3. The filter manifold of claim 1, wherein in the second rotational position, the filter cartridge is secured with the filter manifold, and the inner casing is rotated to the first rotational position to enable a removal of the filter cartridge from the filter manifold.

4. The filter manifold of claim 1, wherein an inner diameter of the chamber is greater than an outer diameter of the cylindrical structure.

5. The filter manifold of claim 1, wherein
the inner surface of the body defines an inlet port and an outlet port, and
the outer surface of the cylindrical structure defines an inlet opening and outlet opening, wherein the inlet opening and the outlet opening are, respectively, arranged aligned with the inlet port and the outlet port at the second rotational position of the inner casing.

6. The filter manifold of claim 5, wherein the inner surface of the body defines
a first groove extending entirely around the inlet port, and
a second groove extending entirely around the outlet port.

7. The filter manifold of claim 6, further including
a first seal arranged inside the first groove and extending partly outwardly from the first groove and arranged contacting the outer surface of the cylindrical structure, and
a second seal arranged inside the second groove and extending partly outwardly from the second groove and arranged contacting the outer surface of the cylindrical structure.

8. The filter manifold of claim 7, wherein the first and second seals are compressed only when the first and second protrusions are in contact with their opposing surface.

9. The filter manifold of claim 1, the first protrusion is formed in a semi-circular shape about the rotational axis of the cylindrical structure and the second protrusion is formed in a semi-circular shape about the insertion axis of the body.

10. The filter manifold of claim 1, wherein the first and second protrusions contact their opposing surface at substantially the same amount of insertion of the inner casing into the chamber of the body.

11. A filter assembly for a refrigeration appliance and adapted to filter water, the filter assembly comprising:
a filter manifold for a filter assembly of a refrigeration appliance, the filter assembly including a filter cartridge adapted to be removably coupled to the filter manifold, the filter manifold comprising:
an outer casing including
a body having a first axial end, a second axial end arranged opposite to the first axial end, and an inner surface defining a chamber with an opening of the chamber arranged at the first axial end, and
a first protrusion extending radially inwardly from the inner surface of the body and extending arcuately along an inner circumference of the chamber; and
an inner casing rotatably arranged in the chamber of the outer casing between a first rotational position and a second rotational position, the inner casing adapted to be removably engaged to the filter cartridge and including:
a cylindrical structure having a rotational axis about which the inner casing rotates, a first end arranged proximate to the first axial end of the body, a second end disposed proximate to the second axial end of the body, and an outer surface arranged facing the inner surface of the body, and
a second protrusion extending radially outwardly from the outer surface of the cylindrical structure and extending arcuately along an outer circumference of the cylindrical structure,
wherein the first protrusion and the second protrusion facilitate an insertion of the inner casing into the chamber along an insertion axis of the body such that the rotational axis of the inner casing, once fully inserted, is arranged at an offset from the insertion axis of the outer casing; and
a filter cartridge partially extending inside the inner casing and removably coupled to the inner casing, wherein the filter cartridge is arranged to receive water from the filter manifold and to filter the water.

12. The filter manifold of claim 11, wherein in the second rotational position, the filter cartridge is secured with the filter manifold, and the inner casing is rotated to the first rotational position to enable a removal of the filter cartridge from the filter manifold.

13. A filter manifold for a filter assembly of a refrigeration appliance, the filter assembly including a filter cartridge adapted to be removably coupled to the filter manifold, the filter manifold comprising:
an outer casing including a body having an inner surface defining a chamber, the inner surface further defining an inlet port, an outlet port, a first groove extending entirely around the inlet port, and a second groove extending entirely around the outlet port;
an inner casing rotatably arranged in the chamber of the outer casing and including a cylindrical structure having a rotational axis about which the inner casing rotates and an outer surface arranged facing the inner surface of the body, wherein the outer surface defines an inlet opening and an outlet opening, respectively, arranged aligned with the inlet port and the outlet port of the body at a rotational position of the inner casing;
a first seal arranged inside the first groove and extending partly outwardly from the first groove and arranged contacting the outer surface of the cylindrical structure; and
a second seal arranged inside the second groove and extending partly outwardly from the second groove and arranged contacting the outer surface of the cylindrical structure.

14. The filter manifold of claim 13, wherein
the outer casing includes a first protrusion extending radially inwardly from the inner surface of the body and extending arcuately along an inner circumference of the chamber, and
the cylindrical structure includes a second protrusion extending radially outwardly from the outer surface of the cylindrical structure and extending arcuately along an outer circumference of the cylindrical structure,
wherein the first protrusion and the second protrusion facilitate an insertion of the inner casing into the chamber along an insertion axis of the body such that the rotational axis of the inner casing, once fully inserted, is arranged at an offset from the insertion axis of the outer casing.

15. The filter manifold of claim 13, wherein
the body includes a first axial end and a second axial end arranged opposite to the first axial end, an opening of the chamber defined at the first axial end, and
the cylindrical structure includes a first end arranged proximate to the first axial end of the body and a second end arranged proximate to the second axial end of the body.

16. The filter manifold of claim 15, wherein
the first protrusion is arranged proximate to the second axial end of the body, and
the second protrusion is arranged proximate to the first end of the cylindrical structure.

17. The filter manifold of claim 14, wherein the first protrusion is formed in a semi-circular shape about the rotational axis of the cylindrical structure and the second protrusion is formed in a semi-circular shape about the insertion axis of the body.

18. The filter manifold of claim 14, wherein the first and second protrusions contact respective opposing surfaces at substantially the same amount of insertion of the inner casing into the chamber of the body.

19. The filter manifold of claim 13, wherein an inner diameter of the chamber is greater than an outer diameter of the cylindrical structure.

20. The filter manifold of claim 14, wherein the first and second seals are compressed only when the first and second protrusions are in contact with their respective opposing surfaces.
